(19) United States
(12) Patent Application Publication
(10) Pub. No.: US 2016/0239155 A1
(43) Pub. Date: Aug. 18, 2016

(54) ADAPTIVE MEDIA

(71) Applicant: Google Inc., Mountain View, CA (US)

(72) Inventor: Pavel Simakov, San Mateo, CA (US)

(21) Appl. No.: 14/625,117

(22) Filed: Feb. 18, 2015

(51) Int. Cl. G06F 3/0481

(52) U.S. Cl. CPC G06F 3/0481

(57) ABSTRACT

Methods, systems, and apparatus, including computer programs encoded on a computer storage medium, for adaptive media. In one aspect, a method includes accessing publication data stored in a memory subsystem of the user device, the publication data defining an adaptive publication that includes a set of publication sections of a publication, each publication section including publication content for display on the user device for user consumption, presenting publication sections for consumption by a user. For each presentation of a particular publication section, the method includes monitoring interactions of the user while the particular publication section is presented, updating, based on the monitored interactions of the user, consumption preferences that describe preferences of the user for consuming content, selecting, based at least in part on the consumption preferences, another publication section for consumption by the user, and presenting another publication section immediately subsequent to the presentation of the particular publication section.

### BACKGROUND

This specification relates to adaptive media.

Electronic media has become an important aspect in the everyday lives of many people. Electronic media provides sources of information, education, and entertainment. Many forms of electronic media systems are web-based, interact with information stored in the cloud, and/or engage with various portions of the internet. Many providers of electronic media provide additional features to ensure that their particular media is user friendly.

### SUMMARY

This specification describes technologies relating to adaptive media.

In general, one innovative aspect of the subject matter described in this specification can be embodied in methods that include the actions of accessing publication data stored in a memory subsystem of the user device, the publication data defining an adaptive publication that includes a set of publication sections of a publication, each publication section including publication content for display on the user device for user consumption, presenting, on the user device, publication sections for consumption by a user. For each presentation of a particular publication section the method further includes monitoring interactions of the user while the particular publication section is presented, updating, based on the monitored interactions of the user, consumption preferences that describe preferences of the user for consuming content, wherein the consumption preferences are updated based on the monitored interactions during the presentation of the particular publication section and at least one publication section presented prior to the particular publication section, selecting, based at least in part on the consumption preferences, another publication section for consumption by the user, and presenting, on the user device, the another publication section immediately subsequent to the presentation of the particular publication section. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. Relevant publication sections are identified and shown to the user based on the user's behavior. This results in the presentment of information that is more likely to satisfy a user's informational need.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example adaptive media system.

FIG. 2A is an illustration of an example electronic reader display.

FIG. 2B is another illustration of an example electronic reader display.

FIG. 3 is a flow diagram of an example adaptive media process.

Like reference numbers and designations in the various drawings indicate like elements.

### DETAILED DESCRIPTION

The systems and methods described below relate to adaptive media that tailors the content of a particular form of media that is presented to a user. Adaptive media helps to provide a user with a personalized user experience. In some implementations, an adaptive media system uses an application programming interface to modify media content based on a user profile, a user's reading history, interactions with the presented content, user location, and other similar information. The adaptive media system monitors the user's interactions with presented media to identify consumption preferences. In particular, the adaptive media system monitors the consumption actions (e.g., how long the media is presented to a user in a reading, viewing and/or listening context, etc.) of the user and analyzes the consumption actions to determine particular media consumption preferences.

The adaptive media system uses the relationship between the user interactions with the content presented to the user to determine consumption preferences. In some implementations, based on the determined consumption preferences and metadata describing the content being processed for presentation, the adaptive media system presents modified content and/or offers to present modified content to the user.

These features and additional features are described in more detail below.

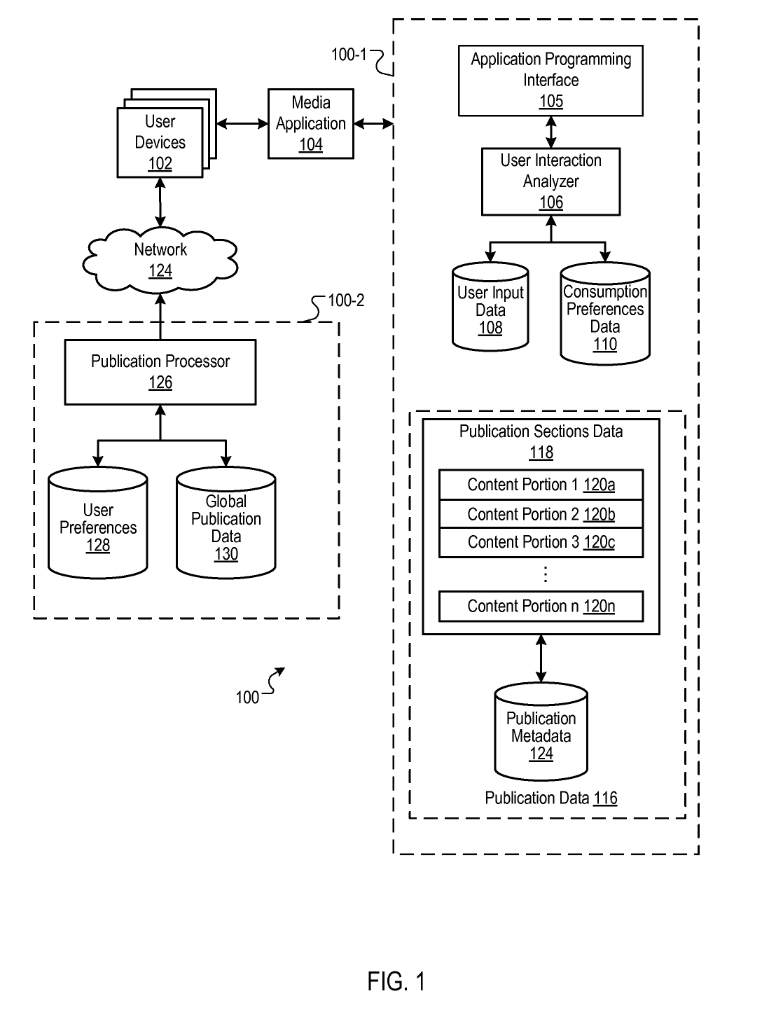

FIG. 1 is a block diagram of an example adaptive media system 100 in which media is modified and presented according to identified consumption preferences. The example adaptive media system 100 can include a user device component 100-1 and a server side component 100-2. In some implementations, only the user device component 100-1 is used. The user device component 100-1 is implemented on a user device 102, which executes a media application 104. The user device component 100-1 includes an application programming interface 105, a user interaction analyzer 106, and publication data 116.

The components 100-1 and 100-2 communicate over a computer network 124, such as a local area network (LAN), wide area network (WAN), the Internet, or a combination thereof. The server side component 100-2 includes a publication processor 126.

A user device 102 is an electronic device that is under the control of a user and is capable of requesting and receiving resources stored in the memory of the user device and/or over the network 124. Example user devices 102 include personal computers, mobile communication devices, mobile computing devices, mobile audio devices and other devices that can send and receive data over the network 124.

The media application 104 can be a video player, a music player, a web-browser, an electronic reader (e-reader), or some other application in which media is presented on the user device 102. The media application 104 enables a user device 102 to display and/or interact with text, images, videos, music and other media typically located within user device memory.

The application program interface (API) 105 communicates with a user interaction analyzer 106, which, in turn, stores and accesses user interaction data 108, and consumption preferences data 110. The API 105 functions as an interface between the media application 104, the user interaction analyzer 106, and publication data 116. The API 105 enables dynamic modification of media content that is presented on the user device 102.

The user interaction analyzer 106 monitors, records, and analyzes user's interactions with the media presented via the media application 104. In some implementations, the user interaction analyzer 106 accesses and updates the user input data 108 and the consumption preferences data 110.

In some implementations, the user interaction analyzer 106, as it monitors user interactions with the presented media, stores user interaction data in the user interaction data 108. The user interaction data is data corresponding to and describing a user's actions with the presented media. Interactions can be explicit, e.g., the taking of an action as received at an input of user device, or implicit, e.g., the lack of request for additional data, which is indicative of a user consuming content. Some examples of user interaction data can include the actions of a user bypassing information or content within the presented media, e.g., quickly “skipping” past a section in an amount of time that is determined to be too short to read the content; interactions indicative of continued interest in a particular section of the media content e.g., dwelling on a section for an amount of time that is determined to be long enough to read the content; highlighting certain portions of media; or any other user observed interactions with the presented media content from which a behavioral signal indicating a user action can be derived.

The user input data 108 can store user interaction data for individual media content according to media type, media title, or any other data categorizing implementation. In some implementations, user interaction data can have a unique identifier that associates the user interaction data with a particular media content. For example, the user input data 108 can be arranged according to user interaction data for each of a particular e-book and e-book title. Thus, for e-book A, all user interaction data in connection with the presentation of e-book A's content is stored in a manner such that it is associated with e-book A in the user input data 108. In some implementations, user interaction data may not be categorized or organized in the user interaction data 108.

In some implementations, the user interaction analyzer 106 accesses and/or generates rules for defining various consumption preferences. Consumption preferences can define the manner in which a user prefers to consume (i.e., read media, watch media, listen to media, interact with media, etc.) particular media content. Consumption preferences can describe categories the user likes or dislikes, subjects or elements of media a user likes or dislikes, e.g., a user may prefer text content over graphical content; ways a user prefers to utilize particular media, etc. For example, consumption preferences can identify which portions or subjects of a particular media content a user prefers to consume. Consumption preferences can also describe similar preferences derived from a larger data set of users. For example, consumption preferences may initially be based on aggregated user preferences, and then modified on a per-user basis.

The user interaction analyzer 106 processes user interactions and derives consumption preferences. For example, if a user skips over a particular subject matter within an electronic book (e-book), the user interaction analyzer 106 can define a consumption preference that the user does not prefer to read content about that particular subject matter. Further, this can indicate the user may not be interested in content relating to that subject matter.

Similar to the user input data 108, the consumption preferences data 110 can be arranged and/or categorized according to similar categorizing mechanism as the user input data repository. For example, consumption preferences may be specific to a particular media item, e.g., a book, or may be specific to the user and be applied to all media items presented on the user device.

Publication data 116 typically includes data defining a particular type of media. In some implementations, the memory location can be a local memory location (e.g., RAM, non-transitory medium, hard drive, etc.) or a cloud based memory location. For example, publication data 116 can be downloaded from a remote location or service and can be stored in a memory location of the user device's hard drive.

In some implementations, publication data 116 can include music, videos, websites, e-books, or any other form of media that can be displayed and/or engaged with on the user device 102. For example, publication data 116 can include data that represents the content of an e-book. Further, and in some implementations, a media application 104 utilizes the publication data 116 to present the content on the user device 102.

Publication data 116 can include other components that interact with each other to present media on a user device 102. In some implementations, the publication data 116 includes publication section data 118, and publication metadata 122.

Media content can be broken into disparate and distinct sections or portions to better organize, store, categorize, or present media content. In some implementations, the publication section data 118 includes data representing portions of a particular media content. For example, an e-book can be parsed into content portion 120a-ns according to chapter, parts of a chapter, subject, keywords, or any other mechanism for breaking down book content into smaller segments.

In some implementations, the publication section data 118 can include an identifying scheme such that each content portion 120a-n has a unique identifier associated with that content portion 120a-n. The unique identifier can be any mechanism to specifically identify each content portion 120a-n disparately from other content portion 120a-ns. In some implementations, each content portion 120a-n may be associated with a different number. For example, a first content portion 120a-n may be associated with a number and each following content portion 120a-n is sequentially numbered from a first content portion 120a-n to the last content portion 120a-n.

In some implementations, each of the content portion 120a-ns within the publication section data 118 has associated publication metadata 122 that describes various attributes of the publication section data 122. In some implementations, the publication metadata 122 describes attributes such as the types of content within the content portion 120a-n, the subject matter of the content portion 120a-n, keywords of the content portion 120a-n, genre of the content portion 120a-n, particular elements of the content portion 120a-n, or any other approach to categorize or characterize individual portions of media content.

Typically, publication metadata 124 is stored with a media item, e.g., with an e-book as part of the e-book. However, publication metadata 124 for a particular media item may be provided separate from the media item, e.g., by a third party service that publishes the metadata 116 for media items.

The API 105, by accessing the user input data 108, consumption preferences 110, and publication metadata 124, can cause the media application 104 to present media content according to the consumption preferences. For example, for an e-book written about various exercise routines and exercise equipment, a consumption preference for a particular user may define a preference for reading content about stationary bikes and/or indoor workouts. Additional content portion 120a-ns that meet this consumption preference as defined by the publication metadata 124 may include additional content portion 120a-ns discussing stationary bikes, treadmills, elliptical machines, and/or indoor workouts.

In another example, consumption preferences may be determined and updated according to the user's affinity towards subject matter pertaining to a particular keyword. This consumption preference can be associated with content portion 120a-ns that have publication metadata that are defined by the particular keyword. For instance, if the user input analyzer 106 has determined that a user highlights or shows interest in the word “yoga”, the analyzer 106 may define a preference for the word “yoga.” Thereafter, additional content portion 120a-ns of the e-book, which include the word “yoga” as characterized by the metadata 124, are identified and offered to the user for viewing.

In some implementations, consumption preferences of the user can be updated based on the monitored user's interactions with content of a particular publication section 110. Accordingly, a consumption preference can describe a user's interest level in a particular entity described in the content of the particular publication section 110. In some implementations, entities are topics of discourse, concepts or things that can be referred to by a text fragment, e.g., a term or phrase, or categorized, and are distinguishable from one another, e.g., based on context.

The API 105 can select another publication section for consumption by the user based at least in part on the consumption preferences. In some implementations, the other publication section can be selected based on the interest levels of the user and the publication section can describe an entity that the user is determined to have a highest interest level relative to interest levels for other entities. For example, the consumption preferences can describe the level of interest the user has in various entities and a consumption preference can describe that a user has the highest level of interest in a particular entity.

Monitoring the interactions of the user while the particular publication section is presented can include monitoring a rate a user skips content that describes a specific entity or category. For example, a user that often skips content about a specific entity or category may define a consumption preference that the user does not have significant interest in that entity or category.

In some implementations, a consumption preference can describe a time preference. A time preference can be based on the time a user spends consuming publication sections that include content that describes one entity relative to time spent consuming publication sections that describe other entities. In some implementations, a consumption preference can be updated defining the user's level of interest in the entity the user spends more time consuming. Thus, the API 105 can select another publication section based on the time preference.

In one example, a user may show more interest in a particular character within one or more chapters of an e-book than other characters within those chapters of the e-book. In some implementations, the user can spend more time reading chapters within the book that involve that particular character. A consumption preference can be created describing the user's interest in that particular character. A different chapter or set of chapters relating to that particular character may be chosen by the API 105 to present to the user to read.

In some implementations, in response to presenting the other publication section for consumption by the user, other different publication sections can be iteratively presented on the user device after the presentation of the other publication section. Typically, the different publication sections include content describing the entity in which the user has the highest interest level. For example, all of the chapters that contain content about the particular character that the user is most interested in can be iteratively presented to the user.

In some implementations, after the last iterated publication section has been selected based on consumption preferences and presented on the user device 102, a predetermined publication section is presented as a next publication section on the user device 102. The predetermined publication section can be a publication section that includes a link to the last presented publication section. Further, the predetermined publication section can be independent of the entity for which the user is determined to have the highest interest level. For example, after a user has exhausted an e-book as a reference resource for a particular interest of a user, then a new topic of interest independent of the consumption preferences may be presented to the user.

In some implementations, the API 105 can determine which of the iteratively presented chapters including content about the particular character is going to be the last chapter presented. In addition, the API 105 may embed a link to another section of the book. In some implementations, the other section of the book is referenced after completing the last of the iteratively presented chapters. For example, the last chapter including content about the particular character that the user has the highest interest in may include a link to the table of contents for that particular e-book. Thus, after the user finishes reading the last of the iteratively presented chapters, the next presented section is the e-book's table of contents.

In some implementations, the predetermined publication section to be consumed by the user after the last iterative publication selection is selected based at least in part on the interest levels of the user. The predetermined publication section can include content that describes an entity that a user is determined to have a next highest interest level relative to the interest level of the entity the user is determined to have the highest interest level. For example, the user interaction analyzer 106 may determine an entity that the user has a next highest interest, e.g., after “indoor workouts,” the user may have a next highest interested in “outdoor running.”

In some implementations, a consumption preference can include a user's reading level preference. For example, if a user's interactions with content presented on a user device includes continuously searching the meaning of words in a dictionary and/or spending more time on each page than other users, it may be determined that the user prefers content to be presented at an easier reading level than currently being presented.

Subsequently and in some implementations, a publication section can be selected to be presented to the user based at least in part on consumption preferences related to a user's reading level preference. In some implementations, a publication section can be selected and the content of the publication can be adjusted so that the reading level of the publication section is within a reading level threshold difference. In some implementations, the reading level threshold difference can describe a reading level preference of a user. The adjusted publication section can be presented to the user for consumption.

In some implementations, different reading level preferences can be defined by various reading level thresholds. For example, the number of different categories of reading level preferences can be divided into a number suitable for operation of the adaptive media system. Further, the reading level threshold can be a measure used to define the various levels of the reading level preferences. The reading level threshold can be utilized to determine a user's reading level preference.

In some implementations, a reading level point system can be used to determine a user's reading level preference. As previously described, the amount of time a user spends reading a page and/or the frequency a user looks up words in a dictionary are two aspects that can impact the reading level point system to help define a user's reading level preference. For example, the amount of time a user spends on a page can add or subtract points, thereby defining a reading level point system.

In some implementations, the reading level point system can be applied to the reading level thresholds. For example, a user's accumulated number of points can be applied to identify where within the reading level thresholds a user's number of points lies. In some implementations, this can define a user's reading level preference.

In some implementations, a publication section for consumption by the user can be selected from a set of two or more publication sections. Each publication section within the set of the two or more publication sections can describe the same concept at reading levels that are different from the other publication sections within the set. The publication section that is chosen to present to a user can have a reading level closest to the user's reading level preference. Alternatively, particular sentences, or even words, may be tagged for substitution based on reading levels. For example, the word “asseveration” may be used in a sentence for a high reading level, but may be substitute with the words “solemn declaration” for a lower reading level.

In some implementations, a consumption preference can include a marked entity preference that is based on content a user marks within a publication section. Marking portions of content within a publication section can define a user's interest in subject matter that is described in the marked portions. A consumption preference that specifies the marked content can also specify the subject matter described in the marked content. For example, a user may use a user device's highlighting or underlining function to mark particular portions of a publication section. The API 105 can select other publication sections to present to a user based on the marked entity preference. By way of a further example, the analyzer 106 may determine that the user marks a profession football player's name, and thus the preference may also specify the sports team or profession sport of the named football player.

In some implementations, a consumption preference can include a dictionary consumption preference that is based on a frequency that the user searches for words in a dictionary. As previously described, frequently checking for words in a dictionary can describe a consumption preference related to a user's reading level preference. Publication sections can be selected for consumption by a user based at least in part on consumption preferences that relate to the dictionary consumption preference.

The API 105 can access the publication data 116, the publication section data 110 and the publication metadata 122. In some implementations, the API 105 processes the consumption preferences and the metadata for the content portion 120a-ns. The content portions that include content, as described by the metadata 122, that meets the consumption preferences is selected for presentation to the user over content that does not meet the consumption preferences.

In some implementations, the API 105 presents an offer to consume media that is contained within the additional content portion 120a-ns. For example, the API 105 may present on the user device 102 a window listing additional content portion 120a-ns that meet the user's consumption preferences. The window may have text within it prompting a user to view the additional content.

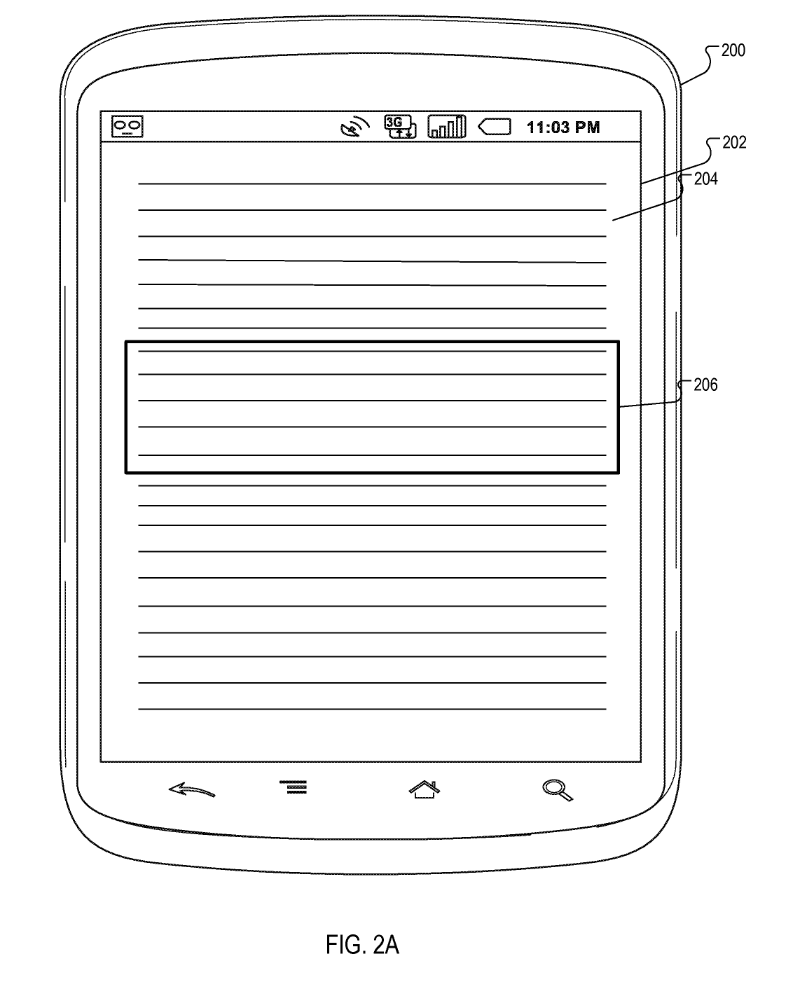

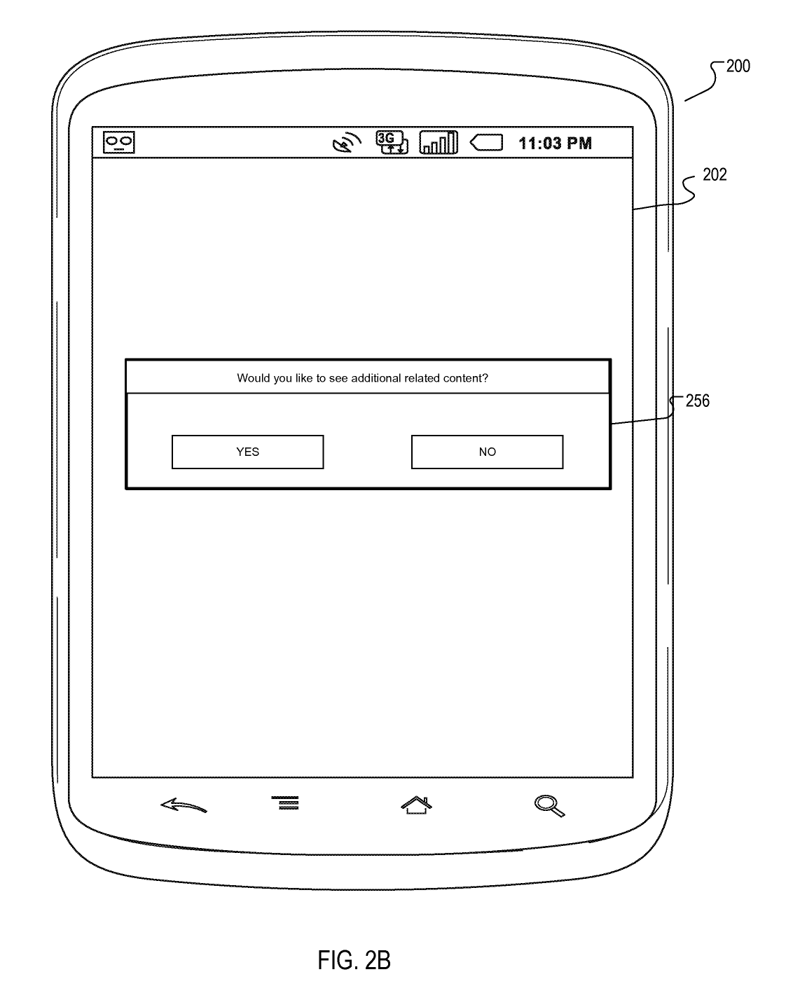

In some implementations, the API 105 automatically presents the media that is contained in the additional content portion 120a-ns relating to a consumption preference on the user device 102. For example, media that is currently being presented on a user device may dynamically modify according to an identified consumption preference. Additional aspects of presenting a user with an offer to consume additional related content will be described in greater detail in connection with FIGS. 2A and 2B.

In some implementations, the API 105 presents a questionnaire to a user to determine the presentation of adaptive media. The questionnaire can be presented each time new media is consumed. The questionnaire can be presented once to determine a user's media modification preferences when a user initially starts a media application for the first time. For example, the questionnaire can ask a user if there is a preference for automatic media modification or if the user should be prompted with media modification options before altering the media being presented.

In some implementations, upon consuming a particular media content for the first time, the questionnaire may ask the user if they are interested in consuming portions of the particular media content that has been deemed popular by the adaptive media system. The adaptive media system can monitor and record popular content portion 120a-ns associated with the consumption activities of other users.

For example, the adaptive media system may acknowledge particular chapters of an e-book that are consumed more than other chapters. The adaptive media system may deem the particular chapters that are more often consumed as popular chapters more relative to other chapters. The adaptive media can also deem the content within the particular chapters as popular subject material. In this instance, the API 105 may offer the user the opportunity to consume the popular chapters, notify the user that the particular chapters have been deemed popular, or notify the user which chapters have been deemed popular.

As previously discussed, the adaptive media architecture can include a publication processor 126 that interacts with a user preferences database 128 and a global publication database 130. In some implementations, the publication processor 126 communicates with the user device 102 via the network 124. For example, the publication processor 126 can receive and record and/or retrieve and transmit data to and from the user preferences database 128 and/or the global publication database 130 to the user device 102.

In some implementations, the API 105 can send identified consumption preferences and media content associated with the identified consumption preferences to the publication processor 126. The publication processor 126 can analyze the data that is received from the API 105 to determine multiple aspects associated with a particular piece of media content. For example, the publication processor 126 can determine user consumption metrics for a particular media content such as parts of the media content that is popular with users, parts of the media content that is not popular with users, average consumption speeds of a user, how many times a user consumes the media within a given time frame, how popular a particular media content is within a different geographical locations, and other similar metrics of the like.

In some implementations, the user preferences database 128 can store the user consumption metric data that is analyzed and identified by the publication processor 126. Upon determining the various user consumption metrics, the publication processor 126 can send the identified user consumption metric data to be stored in the user preferences database 128.

Further, the publication processor 126 can retrieve user consumption metrics from the user preferences database 128 to send to the user device 102. For example, if a user requests for popular content associated with a particular media content, the publication processor 126 will retrieve content that it has determined as popular content for a particular media content and transmit the data to the user device 102.

In some implementations, the user consumption metrics can be associated with a unique identifier to identify each of the user consumption metrics. The publication processor can assign the user consumption metrics a unique identifier such that each piece of data can be specifically accessed.

Users may often use more than one device, and thus the transferring of consumption preferences from one device to another would be advantageous. Accordingly, the adaptive media system can create a user profile that can be applied to multiple devices. In some implementations, the user profile includes data relating to a user's media consumption history, a user's geographical location, and a user's media consumption media preferences (e.g., types of media, genres of media, etc.) The user profile can be stored in the user interaction database 108 or the user profile can be stored in the user preferences database 128. In some implementations, a user's profile can be used to adapt media and/or to recommend media to the user.

In some implementations, the global publication database 130 includes media references (e.g., media titles, media categories, etc.) that can be used to associate user consumption metrics with a particular media content. For example, the global publication data can include video titles, book titles, song titles, a music category, a literary category, and other classification methods of the like. Further, each of the media references can include a unique identifier that can be utilized to identify each media reference.

In some implementations, the global publication database 130 can include a data pointer that links each of the media references in the global publication database 130 to their own respective user consumption metrics within the user publication database 128. The publication processor 126 can access data pertaining to a specific media reference within the global publication database 130 and identify a data location for the specific media reference's associated user consumption preferences according to the data pointer that is included in the specific media reference's data.

As previously described, the adaptive media system 100 can include the user device component 100-1 and the server side component 100-2. In some implementations, the adaptive media processes are executed solely on the user device component 100-1. For example, all data relating to modifying content that is presented to a user is stored on the user device component 100-1. Thus, the user device component 100-1 does not access data within the server side component 100-2 to modify the content presented to a user according to determined consumption preferences.

The adaptive media processes can include the user device component 100-1 downloading data relating to modifying the content presented to a user from the server side component 100-2. For example, the user device component 100-1 may download data that represent modified content portions to present on the user device 102. In some implementations, the adaptive media process can use any suitable combination of user device component resources and server side component resources to modify content presented on the user device 102.

FIG. 2A is an example of a display 202 on an example electronic reader 200. An electronic reader can be an example user device 102. In some implementations, the electronic reader (e-reader) 200 is a device that can be used to read (consume) electronic books (e-books). For example, an e-reader 200 can be a personal computer, a tablet device, a mobile device, or any other device of the like.

As shown in FIG. 2A, the e-reader 200 is displaying example text 204, such as the text of an e-book. For example, the text 204 can be an e-book on fitness, which can include content on different work-outs, exercise routines, exercise equipment, exercise guides, and other content related to fitness and exercising.

The e-reader display 202 also includes a section of highlighted text 206. The highlighted text 206 can be text that has been annotated or highlighted by a user. In some implementations, the user interaction analyzer 106 stores data in the user interaction data repository 108 describing the user's action of highlighting text.

In some implementations, the highlighted text 206 can contain subject matter that a user is interested in, keywords that interest a user, or some other action that defines a user's interest in some aspect of the highlighted text 206. For example, the highlighted text 206 may contain content about treadmills and indoor exercises.

The analyzer 106 processes the highlighted text 206 to define a consumption preference for the user. In this scenario, the highlighted text 206 contains content about treadmills and indoor exercises. Therefore, the user interaction analyzer 106 may determine that the user has a consumption preference for indoor exercises and stationary exercise equipment. In some implementations, the user interaction analyzer 106 stores data describing the user's consumption preference for indoor exercises and stationary exercise equipment in the consumption preferences data 110. As will be discussed in greater detail in connection with FIG. 2B, the API 105 can modify content and/or offer content for consumption according to determined consumption preferences.

FIG. 2B is another illustration of an example e-reader 200 and e-reader display 202. As shown in FIG. 2B, an offer 256 has been presented to view additional related content via a text box. As previously discussed in connection with FIG. 2, the e-reader displayed text 202 and a portion of highlighted text 206 with which the user interaction analyzer 106 determined the user's consumption preference was for indoor exercises and stationary exercise equipment.

The adaptive media system, via the API 105, offers content to be presented on the user device. In some implementations, the modified content can be additional content related to a consumption preference. The modified content can be similar content to the content presented, but altered to accommodate a particular reading level. For example, the API 105 can identify alternative, yet related portions of content to present on the user device 102.

The offer 256 to present modified content can include additional content portion 120a-ns relating to stationary exercise equipment and indoor workouts. For example, the additional content portion 120a-ns can contain content about elliptical exercise machines, stair master exercise machines, stationary bikes, additional content about treadmills. In addition, the additional content portion 120a-ns can contain information about indoor cardio routines, various cardio intensive routines, and other exercise information of the like.

In some implementations, acceptance of the offer 256 can prompt the presentation an interactive list (e.g., a list hyperlinks, deeplinks, clickable uniform resource indicators, etc.). The interactive list can contain short and/or long descriptions of associated content portion 120a-ns and associated selectable links. Upon selection of a selectable link, the user will be shown the content of the associated content portion 120a-n.

In some implementations, acceptance of the offer 256 can present a predetermined content portion 120a-n on the user device 102. The next content portion 120a-n can be presented according to a scheme that classifies or organizes the content portion 120a-ns. For example, the predetermined content portion 120a-n to be presented can be the next content portion 120a-n in the publication sections 110 according to the sequence of unique identifiers that are associated with the content portion 120a-ns.

In some implementations, declination of the offer 256 may cause the adaptive media system to leave or represent the content that was originally presented on the user device. The declination of the offer 236 may cause the next sequential content portion 120a-n to be presented on the user device 102. For example, if a user is currently reading chapter 5 on the e-reader 200 and the user declines an offer to view related content, the media application may present chapter 6 on the e-reader 200. In some implementations, any suitable organized scheme to present a subsequent content portion 120a-n on a user device 102 can be utilized.

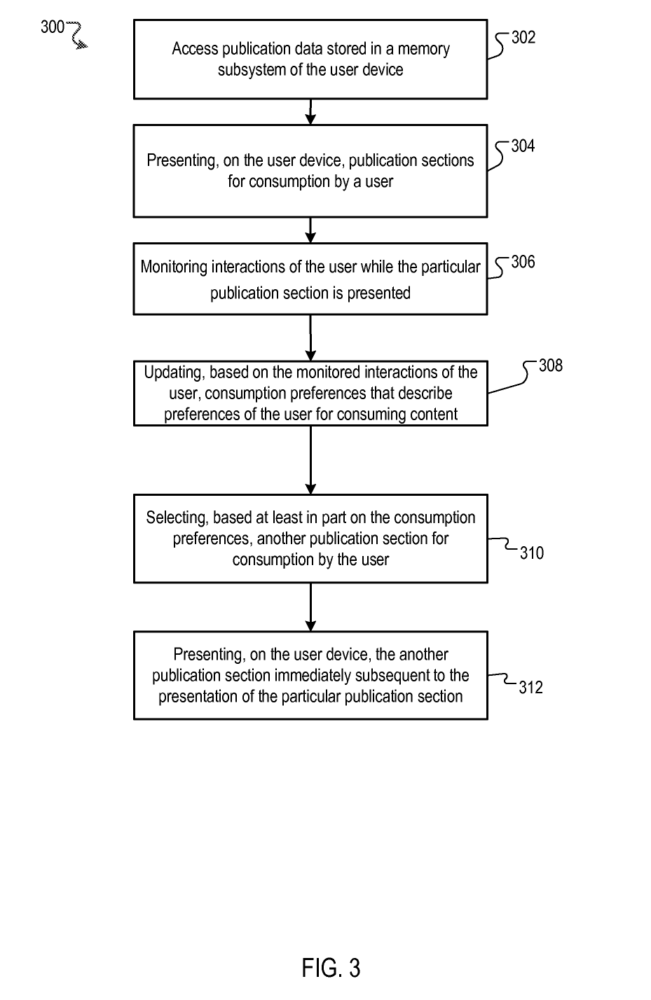

FIG. 3 is a flow diagram of an example adaptive media process. As previously described, the adaptive media system modulates media content presented to a user according to determined consumption preferences for a user. Consumption preferences for the user can be determined according to the user's interaction with the media that is being and/or has been presented.

The process accesses publication data 116 that is stored in a memory subsystem of the user device 102 (302). In some implementations, the publication data 116 defines an adaptive publication that includes a set of publication sections 110. The publication sections 110 can include publication content for display on the user device 102 for user consumption. For example, publication sections 110 can include portions of an e-book (e.g., content portion 120a-ns, chapters, etc.) that can be read on an e-reader 200.

In addition, the adaptive publication can include a corresponding set of publication metadata 122 that describes attributes of the publication section 118 to which the publication section corresponds. In some implementations, the attributes include a description of one or more entities described by the content of the publication section 118. For example, the publication metadata 122 can include keywords, subject matter, main characters, main ideas, and other characteristics and attributes that describe the publication section 118.

The process presents publication sections 110 on the user device 102 for consumption for the user (304). For example, a particular chapter or section of an e-book may be presented on an e-reader 200 for a user to read.

For each publication section that is presented to the user, the process monitors the interactions of the user while the particular publication section is being presented (306). In some implementations, user interactions can include time spent on a page, content that has been skipped, words or sections that have been highlighted, words that have been searched in the dictionary, etc. For example, if a user continuously seeks and reads media content pertaining to a particular subject, the process monitors this interaction and stores data relating to this interaction in the user interaction database 108.

The process updates consumption preferences that describe preferences of the user for consuming content based on the monitored interactions of the user (308). The user interaction analyzer 106 analyzes the user's interactions to determine related or non-related consumption preferences. For example, if a user continuously seeks and reads media content pertaining to a particular subject matter, the user interaction analyzer 106 determines that the user has an affinity for that particular subject matter and a consumption preference will be created accordingly.

Subsequently, the consumption preference will be stored in the consumption preferences database 110 and the consumption preferences will be updated. In some implementations, the consumption preferences are determined and updated based on the monitored interactions of the user during the presentation of the particular publication section and at least one publication section presented prior to the particular publication section. For example, a consumption preference may be determined based on a user's interactions with content of chapter one and chapter two of an e-book.

The process selects another publication section for consumption by the user based at least in part on the consumption preferences (310). In some implementations, consumption preferences can be associated with various publication metadata 122. As previously discussed, publication metadata 122 can be associated with one or more different publication sections 118. The API 105 correlates the consumption preferences with the different publication sections and offers publication sections that either have or have not been consumed for consumption by the user.

The process presents the other publication immediately subsequent to the presentation of the particular publication section on the user device (312). For example, a particular e-book may include present similar content in chapters 1, 2, 3, 6, and 8. After the user reads chapters 1 and 2, the adaptive media may determine that the user has a consumption preference for the content presented in chapters 1 and 2 present chapters 3, 6, and 8 to the user because they contain similar content.

In the forgoing examples, the adaptive media process were discussed with reference to an e-reader media application, buts as previously discussed, the media application can include a web-page, a video viewer, an audio player, and other forms of media of the like.

Additional Implementation Details

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method performed by a user device, comprising:
accessing publication data stored in a memory subsystem of the user device, the publication data defining an adaptive publication comprising:
a set of publication sections of a publication, each publication section including publication content for display on the user device for user consumption;
presenting, on the user device, publication sections for consumption by a user, and for each presentation of a particular publication section:
monitoring interactions of the user while the particular publication section is presented;
updating, based on the monitored interactions of the user, consumption preferences that describe preferences of the user for consuming content, wherein the consumption preferences are updated based on the monitored interactions during the presentation of the particular publication section and at least one publication section presented prior to the particular publication section;
selecting, based at least in part on the consumption preferences, another publication section for consumption by the user; and
presenting, on the user device, the another publication section immediately subsequent to the presentation of the particular publication section.

2. The computer-implemented method of claim 1, wherein:
the adaptive publication includes, for each publication section, a corresponding set of publication metadata that describes attributes of the publication section to which the set of publication metadata corresponds, the attributes including a description of one or more entities described by the content of the publication section;
updating the consumption preferences of the user comprises determining, based on the monitored interactions, for each of the one or more entities described by the content of the particular publication section, an interest level of the user in the entity; and
selecting, based at least in part on the consumption preferences, another publication section for consumption by the user comprises selecting, based at least in part on the interest levels, a publication section describing an entity for which the user is determined to have a highest interest level relative to interest levels for other entities.

3. The computer-implemented method of claim 2, wherein:
in response to presenting the another publication section for consumption by the user, iteratively presenting, on the user device, other publication sections based on each of the other publication sections including content describing entity for which the user is determined to have the highest interest level, each iterative presentation of a publication section being subsequent to the presentation of a previous publication section; and
in response to displaying a last publication section in the iterative presentations, presenting, on the user device, a predetermined publication as a next publication section, the predetermined publication section being a section to which the last presented publication section includes a link, and wherein the predetermined publication section is selected based on the link and independent of the entity for which the user is determined to have the highest interest level.

4. The computer-implemented method of claim 2, wherein:
in response to presenting the another publication section for consumption by the user, iteratively presenting, on the user device, other publication sections based on each of the other publication sections including content describing the entity for which the user is determined to have the highest interest level, each iterative presentation of a publication section being subsequent to the presentation of a previous publication section; and
in response to displaying a last publication section in the iterative presentations, presenting, selecting, based at least in part on the interest levels, a different publication section for consumption by the user, the different publication section being including content describing an entity for which a user is determined to have a next highest interest level relative to the interest level of the entity for which the user is determined to have the highest interest level.

5. The computer-implemented method of claim 1, wherein:
the consumption preferences comprise a user's reading level preference; and
selecting, based at least in part on the consumption preferences, another publication section for consumption by the user comprises:
selecting another publication section;
adjusting the content of publication section so that a reading level of the publication section is within a threshold difference of the user's reading level preference; and
presenting the adjusted content of the publication section.

6. The computer-implemented method of claim 1, wherein:
the consumption preferences comprise a user's reading level preference; and
selecting, based at least in part on the consumption preferences, another publication section for consumption by the user comprises selecting a publication section from a set of two or more publication sections, each publication section in the set describing a same concept and at a reading level different from each other publication section in the set, wherein the selected publication section from the set is a publication section having a reading level closest to the user's reading level preference.

7. The computer-implemented method of claim 1, wherein:
the consumption preferences comprise a time preference based on a time a user spends consuming publication sections that include content describing an entity relative to time spent by the user consuming publication sections describing other entities; and
selecting, based at least in part on the consumption preferences, another publication section for consumption by the user comprises selecting another publication section based on the time preference.

8. The computer-implemented method of claim 1, wherein:
the consumption preferences comprise a marked entity preference based on content a user marks in a publication section; and
selecting, based at least in part on the consumption preferences, another publication section for consumption by the user comprises selecting another publication section based on the marked entity preference.

9. The computer-implemented method of claim 1, wherein:
the consumption preferences comprise a dictionary frequency preference that is based on a frequency that the user searches for words in a dictionary; and
selecting, based at least in part on the consumption preferences, another publication section for consumption by the user comprises selecting another publication section based on the dictionary frequency preference.

10. The computer-implemented method of claim 2, wherein:
monitoring interactions of the user while the particular publication section is presented comprises monitoring a rate a user skips content that describes an entity; and
updating, based on the monitored interactions of the user, consumption preferences that describe preferences of the user for consuming content comprises updating the interest level of the user in the entity based on the rate.

11. A system, comprising:
a data processing apparatus; and
a non-transitory computer readable medium in data communication with the data processing apparatus, and storing instructions that when executed by the data processing to perform operations comprising: access publication data stored in a memory subsystem of the user device, the publication data defining an adaptive publication comprising:
a set of publication sections of a publication, each publication section including publication content for display on the user device for user consumption;
present, on the user device, publication sections for consumption by a user, and for each presentation of a particular publication section:
monitor interactions of the user while the particular publication section is presented;
update, based on the monitored interactions of the user, consumption preferences that describe preferences of the user for consuming content, wherein the consumption preferences are updated based on the monitored interactions during the presentation of the particular publication section and at least one publication section presented prior to the particular publication section;
select, based at least in part on the consumption preferences, another publication section for consumption by the user; and
present, on the user device, the another publication section immediately subsequent to the presentation of the particular publication section.

12. The system of claim 11, wherein:
the adaptive publication includes, for each publication section, a corresponding set of publication metadata that describes attributes of the publication section to which the set of publication metadata corresponds, the attributes including a description of one or more entities described by the content of the publication section;
updating the consumption preferences of the user comprises determining, based on the monitored interactions, for each of the one or more entities described by the content of the particular publication section, an interest level of the user in the entity; and
selecting, based at least in part on the consumption preferences, another publication section for consumption by the user comprises selecting, based at least in part on the interest levels, a publication section describing an entity for which the user is determined to have a highest interest level relative to interest levels for other entities.

13. The system of claim 12, wherein:
in response to presenting the another publication section for consumption by the user, iteratively presenting, on the user device, other publication sections based on each of the other publication sections including content describing the entity for which the user is determined to have the highest interest level, each iterative presentation of a publication section being subsequent to the presentation of a previous publication section; and
in response to displaying a last publication section in the iterative presentations, presenting, on the user device, a predetermined publication as a next publication section, the predetermined publication section being a section to which the last presented publication section includes a link, and wherein the predetermined publication section is selected based on the link and independent of the entity for which the user is determined to have the highest interest level.

14. The system of claim 12, wherein:
in response to presenting the another publication section for consumption by the user, iteratively presenting, on the user device, other publication sections based on each of the other publication sections including content describing the entity for which the user is determined to have the highest interest level, each iterative presentation of a publication section being subsequent to the presentation of a previous publication section; and
in response to displaying a last publication section in the iterative presentations, presenting, selecting, based at least in part on the interest levels, a different publication section for consumption by the user, the different publication section being including content describing an entity for which a user is determined to have a next highest interest level relative to the interest level of the entity for which the user is determined to have the highest interest level.

15. The system of claim 11, wherein:
the consumption preferences comprise a user's reading level preference; and
selecting, based at least in part on the consumption preferences, another publication section for consumption by the user comprises:
selecting another publication section;
adjusting the content of publication section so that a reading level of the publication section is within a threshold difference of the user's reading level preference; and
presenting the adjusted content of the publication section.

16. The system of claim 11, wherein:
the consumption preferences comprise a user's reading level preference; and
selecting, based at least in part on the consumption preferences, another publication section for consumption by the user comprises selecting a publication section from a set of two or more publication sections, each publication section in the set describing a same concept and at a reading level different from each other publication section in the set, wherein the selected publication section from the set is a publication section having a reading level closest to the user's reading level preference.

17. The system of claim 11, wherein:
the consumption preferences comprise a time preference based on a time a user spends consuming publication sections that include content describing an entity relative to time spent by the user consuming publication sections describing other entities; and
selecting, based at least in part on the consumption preferences, another publication section for consumption by the user comprises selecting another publication section based on the time preference.

18. The system of claim 11, wherein:
the consumption preferences comprise a marked entity preference based on content a user marks in a publication section; and
selecting, based at least in part on the consumption preferences, another publication section for consumption by the user comprises selecting another publication section based on the marked entity preference.

19. The system of claim 11, wherein:
the consumption preferences comprise a dictionary frequency preference that is based on a frequency that the user searches for words in a dictionary; and
selecting, based at least in part on the consumption preferences, another publication section for consumption by the user comprises selecting another publication section based on the dictionary frequency preference.

20. The system of claim 12, wherein:
monitoring interactions of the user while the particular publication section is presented comprises monitoring a rate a user skips content that describes an entity; and
updating, based on the monitored interactions of the user, consumption preferences that describe preferences of the user for consuming content comprises updating the interest level of the user in the entity based on the rate.

21. A non-transitory computer readable medium in storing instructions that when executed by a data processing to perform operations comprising:
access publication data stored in a memory subsystem of the user device, the publication data defining an adaptive publication comprising:
a set of publication sections of a publication, each publication section including publication content for display on the user device for user consumption;
present, on the user device, publication sections for consumption by a user, and for each presentation of a particular publication section:
monitor interactions of the user while the particular publication section is presented;
update, based on the monitored interactions of the user, consumption preferences that describe preferences of the user for consuming content, wherein the consumption preferences are updated based on the monitored interactions during the presentation of the particular publication section and at least one publication section presented prior to the particular publication section;
select, based at least in part on the consumption preferences, another publication section for consumption by the user; and
present, on the user device, the another publication section immediately subsequent to the presentation of the particular publication section.
